(19) United States
(12) Patent Application Publication
(10) Pub. No.: US 2025/0243316 A1
(43) Pub. Date: Jul. 31, 2025

(54) POLYURETHANE COMPOSITION, PRODUCT THEREFROM AND METHOD FOR PREPARING THE SAME

(71) Applicant: Dow Global Technologies LLC, Midland, MI (US)

(72) Inventors: Yanbin Fan, Shanghai (CN); Shaoguang Feng, Shanghai (CN); Ping Zhang, Shanghai (CN); Dewen Nie, Shanghai (CN)

(21) Appl. No.: 18/703,387

(22) PCT Filed: Nov. 29, 2021
(86) PCT No.: PCT/CN2021/133917

§ 371 Date: Apr. 22, 2024

(51) Int. Cl. C08G 18/48; C08G 18/12; C08G 18/22; C08G 18/38

(52) U.S. Cl. CPC C08G 18/4812; C08G 18/12; C08G 18/227; C08G 18/3825; C08G 18/4841; C08G 2120/00

(57) ABSTRACT

Provided is a two-component polyurethane composition, comprising, (a) an isocyanate component that comprises: at least one aromatic isocyanate compound, and (b) a polyol component that comprises: at least one polyether polyol compound, a sulfide-free urea or a derivative thereof, an alcohol chain extender, wherein the isocyanate component and polyol component have an NCO/OH ratio of from 0.9:1 to 1.2:1. Also provided are a product prepared using the polyurethane composition, and the preparation method thereof.

### FIELD OF THE DISCLOSURE

The present disclosure relates to a two-component polyurethane composition, a product prepared using the polyurethane composition, and the preparation method thereof.

### BACKGROUND

Reaction injection molding (RIM) is a process in which two or more reactive liquid intermediates (e.g., isocyanate and a polyol compounds) are metered separately and fed to a mixing head where they are combined by high-pressure impingement mixing. The mixed liquids subsequently flow into a mold where they polymerize to form a molded part. The process provides advantages including low pressure, low temperature, and design freedom due to the use of reactive liquid intermediates and has been used in the manufacture of various products or parts including automobile bumpers, medical products, radio and TV cabinets, furniture, sporting equipment, appliances, and business-machine housings.

To enhance the performances (such as light stability, adhesion to in-mold child parts, low odor and mechanical strengths) of the products or parts produced and also the cost efficiency of the production process, efforts have been made in improving polyurethane systems used for RIM applications. To achieve good light stability, aliphatic or alicyclic isocyanates were considered as they provide better light stability in comparison with aromatic isocyanates. However, aliphatic or alicyclic isocyanates are usually costly, low in reactivity and thus time-consuming, and the resultant polyurethanes show inferior mechanical strengths. A polyurethane system based on aromatic isocyanates, using aromatic amines as chain extenders and delayed amino catalysts for prolonging operation time (open time) was developed, but the high cost of aromatic amines and unpleasant odor brought by amino compounds are not favored in many applications especially automotive industry. It has been challenging to provide solutions meeting all the requirements of excellent cost-efficiency, adhesion performance to in-mold child parts, light stability, low odor and outstanding mechanical strengths.

Therefore, there remained an unfulfilled need in the art for a polyurethane system that addresses the above demands.

### SUMMARY OF THE DISCLOSURE

In an aspect, the present disclosure provides a two-component polyurethane composition, comprising,
(a) an isocyanate component that comprises:
   at least one aromatic isocyanate compound, and
(b) a polyol component that comprises:
   at least one polyether polyol compound,
   at least one sulfide-free urea or a derivative thereof, and
   an alcohol chain extender,
wherein the isocyanate component and polyol component have an NCO/OH ratio of from 0.9:1 to 1.2:1.

In a further aspect, the present disclosure provides a polyurethane-based article made by using the two-component polyurethane composition described herein.

In a further aspect, the present disclosure provides a method of preparing a polyurethane-based article, comprising,
(i) providing an isocyanate component that comprises:
   at least one aromatic isocyanate compound,
(ii) providing a polyol component that comprises:
   at least one polyether polyol compound,
   at least one sulfide-free urea or a derivative thereof, and
   an alcohol chain extender,
(iii) combining the isocyanate component with the polyol component at an NCO/OH ratio of from 0.9:1 to 1.2:1 to form a reactive mixture, and
(iv) curing the reactive mixture to form a polyurethane-based article.

In a further aspect, the present disclosure provides use of the two-component polyurethane composition in the manufacture of a polyurethane-based article.

It is to be understood that both the foregoing general description and the following detailed description are exemplary and explanatory only and are not restrictive of the invention, as claimed.

### DETAILED DESCRIPTION OF THE DISCLOSURE

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative”. All ranges include endpoints unless otherwise indicated.

As disclosed herein, all percentages mentioned herein are by weight, and temperatures in ° C., unless specified otherwise.

### A. Polyurethane Composition

In an aspect, the present disclosure provides a two-component polyurethane composition, comprising,
(a) an isocyanate component that comprises:
   at least one aromatic isocyanate compound, and
(b) a polyol component that comprises:
   at least one polyether polyol compound,
   at least one sulfide-free urea or a derivative thereof, and
   an alcohol chain extender,
wherein the isocyanate component and polyol component have an NCO/OH ratio of from 0.9:1 to 1.2:1.

As used herein, the term “two-component” means that the polyurethane composition is provided in parts separated from each other before making them react. In an illustrative embodiment of the present disclosure, the isocyanate component and the polyol component can be prepared, stored, transported and served separately, and combined shortly or immediately, for example, in a mixer (e.g., a speed-mixer), to form a reactive mixture. It is contemplated that when these two components are brought into contact, a curing reaction begins in which the polyol groups react with the isocyanate groups to form urethane links. The reactive polyurethane composition formed by bringing the two components into contact can be referred to as “reactive liquid intermediates” or a “reactive mixture.”

The isocyanate component and polyol component have an NCO/OH ratio of from 0.9:1 to 1.2:1. In some embodiments, the NCO/OH ratio is within the range obtained by combining any two of the following endpoints: 0.9:1, 1:1, 1.1:1 and 1.2:1. In some embodiments, the NCO/OH ratio is within the range of from 0.9:1 to 1.1:1, from 1:1 to 1.2:1, or from 1:1 to 1.1:1. As used herein, the term “NCO/OH ratio” refers to the ratio of the number of isocyanate groups to the number of hydroxyl groups in the polyurethane foam composition; or more specifically, the ratio between the number of isocyanate groups in the isocyanate component and the number of hydroxyl groups in the polyol component, of the polyurethane foam composition according to the present disclosure.

### Isocyanate Component

The isocyanate component comprised in the two-component polyurethane composition of the present disclosure comprises one or more aromatic isocyanate compounds, especially aromatic polyisocyanates. Various modified or unmodified monomeric isocyanates, polymeric isocyanates, isocyanate-terminated prepolymers and any combination thereof can be used in the present disclosure.

As used herein, an “isocyanate monomer” or a “monomeric isocyanate” is any compound that contains two or more isocyanate groups. An “aromatic isocyanate” is an isocyanate that contains one or more aromatic rings.

As used herein, “isocyanate-terminated prepolymers” refer to those prepared by reacting an excess of polyisocyanates with polyols, including aminated polyols or imines/enamines thereof, or polyamines.

Examples of monomeric aromatic isocyanates suitable for use according to the disclosure include, but are not limited to, isomers of methylene diphenyl diisocyanate (“MDI”) such as 4,4-MDI, 2,4-MDI and 2,2′-MDI, or modified MDI such as carbodiimide modified MDI or allophanate-modified MDI; isomers of toluene-diisocyanate (“TDI”) such as 2,4-TDI, 2,6-TDI, isomers of naphthalene-diisocyanate (“NDI”) such as 1,5-NDI, m- and p-phenylene diisocyanate, chlorophenylene-2,4-diisocyanate, diphenylene-4,4′-diisocyanate, 3,3′-dimethyl-4,4′-diphenyl-diisocyanate, 3-methyldiphenyl-methane-4,4′-diisocyanate, diphenyletherdiisocyanate, 2,4,6-triisocyanatotoluene, 2,4,4′-triisocyanatodiphenylether, and combinations thereof.

A mixture of isocyanates can also be used in the isocyanate component. For example, a mixture of isocyanates can include monomeric MDI, monomeric TDI, and/or MDI or TDI based prepolymers. In an exemplary embodiment, the isocyanate component can comprise a mixture of at least one monomeric aromatic isocyanate, at least one carbodiimide modified monomeric isocyanate, and at least one prepolymer of monomeric aromatic isocyanates and short chain diols. In another exemplary embodiment, the isocyanate component can comprise a mixture of different monomeric MDI, carbodiimide modified monomeric MDI and monomeric MDI quasi-prepolymers based on short chain diols. The short chain diols can comprise polyols having two functional hydroxyl groups and a molecular weight of up to 300 g/mol. In some embodiments, the short chain diols are C2 to C12 diols (i.e., comprising from 2 to 12 carbon atoms), for example, C2 to C10 diols, or C2 to C8 diols. In some embodiments, the short chain diols are of aliphatic or cyclo-aliphatic type. In some embodiments, the short chain diols are those with only hydroxyl functional groups. Exemplary short chain diols can include, but are not limited to, ethylene glycol, diethylene glycol, triethylene glycol, 1,2-propylene glycol, dipropylene glycol, tripropylene glycol, 1,3-propane diol, 1,4-butane diol, neopentyl glycol, 1,5-pentane diol, 1,6-hexane diol, cyclohexane dimethanol, or a mixture thereof.

Aromatic isocyanate compounds are at least 70%, for example, at least 75%, at least 80%, at least 85%, or at least 90%, by weight of the isocyanate component.

Compounds having isocyanate groups, such as the aromatic isocyanate compounds of the isocyanate component, may be characterized by the parameter “% NCO,” or “—NCO content”, which is the amount of isocyanate groups by weight of the compound. In some embodiments, the aromatic isocyanate compound has a free —NCO content of between 12% and 32%, for example, between 15% and 32% or between 12% and 28%, by weight of the aromatic isocyanate compound.

In some embodiments, the aromatic isocyanate has a viscosity of below 1500 mPa·s, for example, below 1400 mPa·s, or below 1300 mPa·s, at room temperature.

The isocyanate component can, optionally, comprise one or more additional auxiliary agents and/or additives for specific functions or purposes. In some embodiments, the isocyanate component can comprise a peroxide decomposer to get better weather resistance. For example, a peroxide decomposer of an aliphatic or aromatic organophosphite type may be useful. In some embodiments, the isocyanate component can comprise, optionally, one or more of anti-foaming agents, foam stabilizers, anti-statistic reagents, plasticizers, flame-retardant agents, fillers, colorants, pigments, etc. In an exemplary embodiment, the pigments are preferably dispersion of carbon black, titanium dioxide and isoindolinon in polyols.

### Polyol Component

The polyol component comprised in the two-component polyurethane composition of the present disclosure comprises one or more polyether polyol compounds.

A compound that contains two or more ether linkages in the same linear chain of atoms is known herein as a “polyether.” A compound that is a polyether and a polyol is a “polyether polyol.”

Polyether polyols used in the polyol component can include diols, triols, tetraols or combinations thereof.

As used herein, the term “polyol” refers to a compound with two or more hydroxyl groups. A polyol is a “diol” when it has exactly two hydroxyl groups, a “triol” when it has exactly three hydroxyl groups, a “tetraol” when it has exactly four hydroxyl groups, a “pentanol” when it has exactly five hydroxyl groups, and so on.

Polyether polyols is at least 60%, for example, at least 65%, at least 70%, at least 75%, at least 80%, or at least 85%, by weight of the polyol component. In some embodiments, the polyether polyol is from 60% to 95%, for example, from 65% to 90%, from 70% to 90%, or from 75% to 90%, by weight of the polyol component.

In some embodiments, the one or more polyether polyols comprised in the polyol component have an average hydroxyl group functionality of no more than 5. In some embodiments, the one or more polyether polyols comprised in the polyol component have an average hydroxyl group functionality of no less than 2. In some embodiments, the one or more polyether polyols in the polyol component have an average hydroxyl group functionality that is within the numerical range obtained by combining any two of the following endpoints: 2, 2.5, 3, 3.5, 4, 4.5 and 5. In some embodiments, the polyether polyols have an average hydroxyl group functionality of from 2 to 5, from 2 to 4, from 3 to 5, from 4 to 5 or from 2 to 3.

In some embodiments, the one or more polyether polyols comprised in the polyol component have an average molecular weight of no less than 800 g/mol. In some embodiments, the one or more polyether polyols comprised in the polyol component have an average molecular weight of no more than 12000 g/mol. In some embodiments, the one or more polyether polyols comprised in the polyol component have an average molecular weight that is within the numerical range obtained by combining any two of the following endpoints: 800, 1000, 2000, 3000, 4000, 5000, 6000, 7000, 8000, 9000, 10000, 11000 and 12000 g/mol. In some embodiments, the polyether polyols have an average molecular weight of from 800 to 12000 g/mol, from 1000 to 12000 g/mol, from 2000 to 12000 g/mol, from 3000 to 12000 g/mol, from 800 to 11000 g/mol, from 800 to 10000 g/mol, from 800 to 9000 g/mol, from 1000 to 10000 g/mol, from 2000 to 8000, or from 3000 to 7000 g/mol.

In some embodiments, the one or more polyether polyols comprised in the polyol component have an average hydroxyl group number of no less than 20 mg KOH/g. In some embodiments, the one or more polyether polyols comprised in the polyol component have an average hydroxyl group number of no more than 1000 mg KOH/g. In some embodiments, the one or more polyether polyols comprised in the polyol component have an average hydroxyl group number that is within the numerical range obtained by combining any two of the following endpoints: 20, 50, 100, 200, 300, 500, 700, 800, 1000 mg KOH/g. In some embodiments, the one or more polyether polyols comprised in the polyol component have an average hydroxyl group number of from 20 to 1000 mg KOH/g, from 20 to 800 mg KOH/g, from 20 to 500 mg KOH/g, or from 20 to 200 mg KOH/g.

In some embodiments, the polyether polyols are polypropylene oxide-based polyols. In some embodiments, the polyether polyols have less than 20%, preferably less than 15% of polyethylene oxide in the total amount of the polyether polyols. To facilitate efficient curing and demolding, the polyether polyols contain at least 70%, for example, at least 75%, at least 80%, at least 85% of primary hydroxyl groups.

The polyol component comprised in the two-component polyurethane composition comprises a sulfide-free urea or derivatives thereof.

As used herein, the term “sulfide-free urea” refers to a urea compound that does not contain sulfur, especially bivalent sulfur in its structure.

In some embodiments, the sulfide-free urea or a derivative thereof useful in the present disclosure comprises the structure of the following formula:

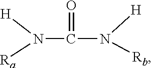

wherein Rₐ and R_{b} are independently H or C₁-C₁₀ aliphatic chain with OH or NH₂ as a terminal group. Suitable examples of sulfide-free ureas include urea, (2-hydroxyethyl)urea, 1,3-bis(hydroxymethyl)urea, carbamoylurea, N,N′-Methylenebis[N′-3-(hydroxymethyl)-2,5-dioxo-4-imidazolidinyl]urea, etc.

In some embodiments, sulfide-free urea or derivatives thereof is at least 0.1%, for example, at least 0.3%, at least 0.5% or at least 1%, by weight of the polyol component. In some embodiments, sulfide-free urea or derivatives thereof is no more than 20%, for example, no more than 18%, no more than 15%, no more than 12% or no more than 10%, by weight of the polyol component. In some embodiments, sulfide-free urea or derivatives thereof is from 0.1% to 20%, for example, from 0.1% to 15%, from 0.1% to 12%, from 0.2% to 12%, or from 0.2% to 10%, by weight of the polyol component.

The polyol component comprised in the two-component polyurethane composition of the present disclosure comprises an alcohol chain extender.

In some embodiments, the alcohol chain extender is at least 1%, for example, at least 2%, at least 3%, at least 4% or at least 5%, by weight of the polyol component. In some embodiments, an alcohol chain extender is no more than 20%, for example, no more than 18%, no more than 15%, no more than 12% or no more than 10%, by weight of the polyol component. In some embodiments, an alcohol chain extender is from 1% to 20%, for example, from 2% to 18%, from 3% to 15%, or from 4% to 12%, by weight of the polyol component.

The alcohol chain extender comprised in the polyol component can comprise short chain polyols. In some embodiments, the short chain polyols are C2 to C12 polyols (i.e., comprising from 2 to 12 carbon atoms), for example, C2 to C10 polyols, or C2 to C8 polyols. In some embodiments, the short chain polyols are of aliphatic or cyclo-aliphatic type. In some embodiments, the short chain polyols are those with only hydroxyl functional groups.

In some embodiments, the short chain polyols comprised in the polyol component have a hydroxyl group functionality of from 2 to 8, for example, from 2 to 7, from 2 to 6, from 2 to 5 or from 2 to 4.

Suitable examples of the short chain polyols comprised in the polyol component include but not limited to ethylene glycol, propane diol, butane diol, pentane diol, hexane diol, 1,4-cyclohexane dimethanol, isomers thereof, or combinations thereof.

In some embodiments, the two-component polyurethane composition does not include an aromatic amine (for example, diethyl toluene diamine) as chain extender. In some embodiments, the two-component polyurethane composition does not include a sulfide-containing urea (for example, thiourea) as chain extender.

Various types of optional components can be present in the two-component polyurethane composition according to the present disclosure.

One or more catalysts can be incorporated into the polyurethane composition, in one or both of the polyol component and isocyanate component. Preferably, the catalysts include an organometallic catalyst.

Suitable organometallic catalysts for use in the present disclosure can include, but not limited to organotin (II or IV) catalyst, organobismuth (III) catalyst, organozinc (II) catalyst, and combinations thereof.

In a particular embodiment, the organotin (II or IV) catalyst has the following formula (1)

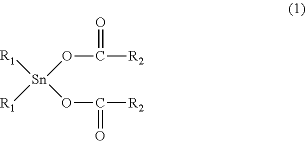

the following formula (2):

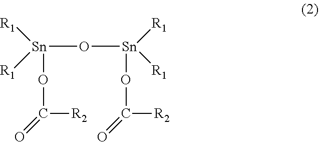

or the following formula (3):

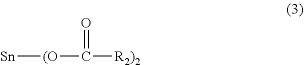

wherein,
R₁ is a C₁-C₈ alkyl group; and, R₂ is either: a linear or branched C₁₃-C₁₉ alkyl or alkenyl group, or a linear or branched C₁-C₁₉ alkyl or alkenyl group, preferably a C₇-C₁₉ alkyl or alkenyl group, substituted with at least one isocyanate-reactive group, in particular with one or more OH⁻, NH⁻ and/or NH₂⁻ groups.

In another particular embodiment, the organobismuth (III) catalyst has the following formula (4):

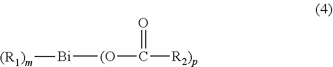

wherein,
m=0-2, p=1-3, m+p=3, R₁ is a C₁-C₈ alkyl group; and R₂ is either: a linear or branched C₁₃-C₁₉ alkyl or alkenyl group, or a linear or branched C₁-C₁₉ alkyl or alkenyl group, preferably a C₇-C₁₉ alkyl or alkenyl group, substituted with at least one isocyanate-reactive group, in particular with one or more OH⁻, NH⁻ and/or NH₂⁻ groups.

In another particular embodiment, the organozinc (II) catalyst has the following formula (5):

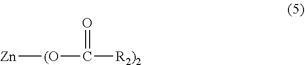

wherein,
R₂ is a C₁ to C₁₉ alkyl or alkenyl group, which may be linear or branched and which may be substituted or not. Preferably, R₂ is a C₁ to C₁₂ alkyl or alkenyl group since those zinc catalysts are liquid which is preferable in view of the processability thereof.

In some embodiments where the polyol component comprises a catalyst, the catalyst is at least 0.05%, for example, at least 0.08%, at least 0.1%, at least 0.12%, or at least 0.15%, by weight of the polyol component. In some embodiments where the polyol component comprises a catalyst, the catalyst is no more than 8%, for example, no more than 5%, no more than 3%, no more than 1%, or no more than 0.5%. In some embodiments where the polyol component comprises a catalyst, the catalyst is from 0.05% to 8%, for example, from 0.05% to 5%, from 0.05% to 3%, from 0.08% to 1%, or from 0.1% to 0.5%, by weight of the polyol component.

One or more antioxidants can be incorporated into the polyurethane composition, in one or both of the polyol component and isocyanate component.

Suitable antioxidants include phenolic types, organic phosphites, phosphines and phosphonites, hindered amines, organic amines, organo sulfur compounds, lactones and hydroxylamine compounds. In some embodiments, the antioxidant can be a primary antioxidant. As used herein, the term “primary antioxidant” refers to a molecule which is capable of quenching free radicals in a polyethylene matrix. In a preferred embodiment, the antioxidant is of sterically hindered phenol type.

In some embodiments where an antioxidant is comprised in the polyol component, the antioxidant is at least 0.3%, for example, at least 0.4%, or at least 0.5%, by weight of the polyol component. In some embodiments where an antioxidant is comprised in the polyol component, the antioxidant is no more than 2%, for example, no more than 1.8%, no more than 1.5%, or no more than 1.2%. In some embodiments where an antioxidant is comprised in the polyol component, the antioxidant is from 0.3% to 2%, for example, from 0.3% to 1.8%, from 0.3% to 1.5%, from 0.4% to 1.2%, or from 0.5% to 1%, by weight of the polyol component.

One or more UV absorbers can be incorporated into the polyurethane composition, in one or both polyol component and isocyanate component.

Representative UV absorbers include benzotriazole types. In some embodiments where a UV absorber is comprised in the polyol component, the UV absorber is at least 0.5%, for example, at least 0.8%, or at least 1.0%, by weight of the polyol component. In some embodiments where a UV absorber is comprised in the polyol component, the UV absorber is no more than 2.5%, for example, no more than 2.2%, no more than 2%, or no more than 1.8%, by weight of the polyol component. In some embodiments where a UV absorber is comprised in the polyol component, the UV absorber is from 0.5% to 2.5%, for example, from 0.5% to 2.2%, from 0.8% to 2.0%, or from 1.0% to 1.8%, by weight of the polyol component.

One or more UV stabilizers can be incorporated into the polyurethane composition, in one or both polyol component and isocyanate component.

Representative UV stabilizers include a hindered aliphatic light stabilizer (HALS). In some embodiments, the UV stabilizers include substituted alicyclic-amine types. In some embodiments where a US stabilizer is comprised in the polyol component, the UV stabilizer is at least 0.5%, for example, at least 0.8%, or at least 1.0%, by weight of the polyol component. In some embodiments where a US stabilizer is comprised in the polyol component, the UV stabilizer is no more than 2.5%, for example, no more than 2.2%, no more than 2%, or no more than 1.8%, by weight of the polyol component. In some embodiments where a US stabilizer is comprised in the polyol component, the UV stabilizer is from 0.5% to 2.5%, for example, from 0.5% to 2.2%, from 0.8% to 2.0%, or from 1.0% to 1.8%, by weight of the polyol component.

Further auxiliary agents and/or additives for specific functions or purposes can be comprised in the polyurethane composition. For example, the polyol component can, optionally, comprise one or more of anti-foaming agents, foam stabilizers, anti-statistic reagents, plasticizers, flame-retardant agents, fillers, colorants, pigments, etc. In an exemplary embodiment, the pigments are preferably dispersion of carbon black or titanium dioxide in polyols.

### B. Polyurethane-Based Article

In a further aspect, the present disclosure provides a polyurethane-based article made by using the two-component polyurethane composition described herein.

In some embodiments, the product can be a molded polyurethane-based article. In some embodiments, the polyurethane-based article is made via a molding process, for example, an elastomeric polyurethane molding process. In some embodiments, the polyurethane-based article can be produced using the two-component polyurethane composition described herein via processes including but not limited to, vacuum casting, Liquid Injection Molding (LIM), Reactive Injection Molding (RIM), Resin Transfer Molding (RTM), Automatic Pressure Gelation (APG), and the like. In some embodiments, the polyurethane-based article is made via an RIM process.

### C. Preparation of Polyurethane-Based Article

In a further aspect, the present disclosure provides a method of preparing a polyurethane-based article, comprising,
(i) providing an isocyanate component that comprises:
   at least one aromatic isocyanate compound,
(ii) providing a polyol component that comprises:
   at least one polyether polyol compound,
   at least one sulfide-free urea or a derivative thereof, and
   an alcohol chain extender,
(iii) combining the isocyanate component with the polyol component at an NCO/OH ratio of from 0.9:1 to 1.2:1 to form a reactive mixture, and
(iv) curing the reactive mixture to form a polyurethane-based article.

In some embodiments, the NCO/OH ratio is within the range obtained by combining any two of the following endpoints: 0.9:1, 1:1, 1.1:1 and 1.2:1. In some embodiments, the NCO/OH ratio is within the range of from 0.9:1 to 1.1:1, from 1:1 to 1.2:1, or from 1:1 to 1.1:1.

Preferably, the method is carried out by using a two-component polyurethane composition according to the present disclosure.

Before the combining step, the isocyanate component and the polyol component are provided in parts separated from each other, for example, stored or placed in different containers or feed vessels.

In the combining step, the isocyanate component and the polyol component are brought into contact, for example, in a mixer (e.g., a speed-mixer) to mix and form a reactive mixture. The reactive mixture can then be cured to form a polyurethane-based article.

In some embodiments, the method can further comprise a molding step in which the reactive mixture is poured immediately (for example, within 5 minutes, preferably within 1 minute, more preferably with 30 seconds) after it is formed into a mold, where the reactive mixture is cured to form a molded article.

In some embodiments where the method comprises a molding step, the molding step is carried out at ambient temperature, generally from 15° C. to 35° C., for example, from 20° C. to 25° C.

In some embodiments where the method comprises a molding step, the method can further comprise a demolding step in which the molded article is removed from the mold. The demolded articles can be further treated, for example, polished, drilled, or assembled into a desired product or part, for example, for use in applications such as automobile bumpers, medical products, radio and TV cabinets, furniture, sporting equipment, appliances, and business-machine housings.

In some embodiments, the method is carried out via molding process, for example, an elastomeric polyurethane molding process. In some embodiments, the method is carried out via processes including but not limited to vacuum casting, Liquid Injection Molding (LIM), Reactive Injection Molding (RIM), Resin Transfer Molding (RTM), Automatic Pressure Gelation (APG), and the like. In some embodiments, the method is carried out via an RIM process.

### D. Application of the Polyurethane Composition

In a further aspect, the present disclosure provides use of the two-component polyurethane composition in the manufacture of a polyurethane-based article.

In some embodiments, the polyurethane-based article is a molded article. In some embodiments the polyurethane-based article is made by using the two-component polyurethane composition and/or the method as described above. In some embodiments, the molded article is manufactured via an RIM process.

It has been surprisingly found by the inventors that the polyurethane-based articles produced by the described method, or by using the two-component polyurethane composition according to the present disclosure provide excellent cost-efficiency, adhesion performance to in-mold child parts, light stability, low odor and outstanding mechanical strengths.

In some embodiments, the polyurethane-based articles produced according to the present disclosure have a Shore A hardness of from 75 A to 100 A, for example, from 85 A to 100 A, or from 90 A to 100 A, as measured using a Shore A analyzer under method of ASTM D2240.

In some embodiments, the polyurethane-based articles produced according to the present disclosure have a tensile strength of higher than 10 MPa, as measured in accordance to ASTM D 638.

In some embodiments, the polyurethane-based articles produced according to the present disclosure have an ultimate elongation of greater than 200%, for example, greater than 210% or greater than 220%, as measured in accordance to ASTM D 638.

In some embodiments, the polyurethane-based articles produced according to the present disclosure have an odor score of at or above Grade 6, preferably at or above Grade 7, as evaluated according to GMW3205-2016.

### EXAMPLES

Some embodiments of the disclosure will now be described in the following Examples, wherein all parts and percentages are by weight unless otherwise specified.

### 1. Raw Materials

Raw materials used in the examples are listed in Table 1.

TABLE 1
Raw materials used in the examples.

| Component | Raw Material | Detailed Information | Supplier |
|---|---|---|---|
| Polyether polyol | VORANOL ™ CP | 14% EO capped propoxylated glycerin triol with | Dow |
| | 6001 | a MW of 6000. | |
| Polyether polyol | VORANOL ™ EP | 20% EO capped propoxylated propylene | Dow |
| | 1900 | glycol diol with a MW of 4000. | |
| Prepolymer | HYPERLAST ™ | MDI compounds containing 50% | Dow |
| | LE 5021 | carbodiimide-modified MDI, 26% pure MDI and | |
| | | 24% prepolymers of MDI and short | |
| | | chain diols of DPG, and TPG. | |
| Antioxidant | IRGANOX 1135 | β-(3,5-di-tert-butyl-4-Hydroxylphenyl | BASF |
| | | propionate isooctanol ester, | |
| | | 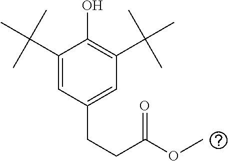 [SMILES: COC(=O)CCc1cc(C(C)(C)C)c(O)c(C(C)(C)C)c1] | |
| UV absorber | Tinuvin 571 | 2-(2H-benzotriazo-2-yl)-6-dodecyl-4- | BASF |
| | | methyl-Phennol, | |
| | | 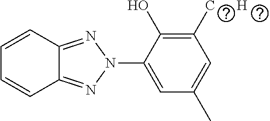 | |
| UV stabilizer | Tinuvin 765 | Bis(1,2,2,6,6-pentamethyl-4-piperidyl) | BASF |
| | | sebacate, | |
| | | 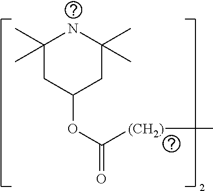 | |
| Anti-foamer | BYK 535 | Silicone-based anti-foamer | Byk Chemical GmbH |
| Chain extender | Monoethylene Glycol (MEG) | 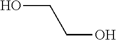 | Shanghai Tony Trade Co., Ltd. |
| Chain extender | Urea | 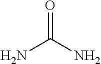 | Sinopharm Chemical Reagent Co., Ltd |
| Chain extender | Thiourea | 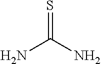 | Sinopharm Chemical Reagent Co., Ltd |
| Chain extender | 1,3- bis(hydroxymethyl) urea | 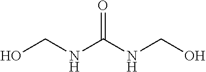 | Merck |
| Chain extender | Diethyl toluene diamine (DETDA) | 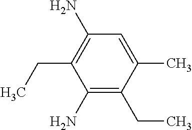 | Zhangjiagang Yarui Chemical Co., Ltd. |
| Organobismuth | Coscat 83 | Bismuth(III) neodecanoate, 16% Bismuth | Vertellus LLC |
| catalyst | | content | |

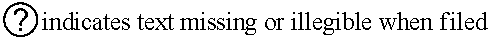

### 2. Experimental

### 2.1 Preparation of Molded Polyurethane Elastomers

Polyurethane elastomer moldings were prepared via mixing the polyol and prepolymer components using a speed-mixer at 3000 rpm for 6 seconds and then pouring the mixtures into an open and vertical aluminum mold at room temperature. The PU moldings were then obtained after curing and demolding of the systems at room temperature for 24 h. Testing samples were then cut and sent for determination of physical properties and heat as well as UV stability.

### 2.2 Physical Properties

Hardness of the polyurethanes was characterized 4 times in parallel for each polyurethane sample using a Shore A analyzer under method of ASTM D2240. Specimen for testing of tensile strength and elongation at break were prepared in accordance to ASTM D 638. Test specimen were conditioned in an ASTM lab for 16 h (23° C., 50% RH) before testing. Samples were tested with pneumatic grips and in tension at a crosshead displacement speed of 50 mm/min. Testing was performed on 10 specimens for each testing.

### 2.3 UV Stability

(a) Exposure to ultraviolet radiation obtained by using a Xenon lamp and adapted filters.
(b) Irradiance of 0.55 W/m² at 340 nm.
(c) Thermometer temperature setting: 70±2° C.
(d) Sprinkling condition: water vapor at 50±2° C.
(e) Sprinkling frequency (only on the exposed side of the test specimens): 120 minutes of sprinkling followed by 102 minutes without sprinkling.
(f) Relative humidity: 50%±5% without sprinkling period.

Yellow Index Change (ΔYI) after 72 h of irradiance is used to evaluate the UV stability of the polyurethanes.

### 2.4 Adhesion Performance

Glasses coated with ceramics were firstly cleaned up with dry alcohol. After 2 mins, pre-treatment agent EFTEC™ DV 646 was applied using brushes on the surfaces. After 15-min drying under fume hood with face velocity of air 0.5 meter/s, primer EFTEC™ DV 930 was applied onto the pretreated surfaces within 2 hours. Within 2-h post-treatment of the primer, liquid mixtures of isocyanates and different formulated polyols were mixed and poured onto the treated surfaces. The experimental glasses were put at room temperature for curing and peel strength at 90° was determined using Instron instrument at room temperature.

### 2.5 Odor Evaluation

10 cm×10 cm plates of different formulations of the polyurethanes were casted and allowed for curing at room temperature for 24 hrs. Odor performances of each plate were evaluated according to GMW3205-2016 and each sample was scored according to below standards.

### Notes:

### Nomenclature for Evaluation Scale:

| Evaluation | Description for all | Description for |
|---|---|---|
| scale | materials except leather | leather materials |
| Grade 10 | Odorless | Odorless |
| Grade 9 | Just noticeable | Just noticeable |
| Grade 8 | Noticeable, trace | Noticeable, trace |
| Grade 7 | Clearly noticeable, | Clearly noticeable, |
| | but not objectionable | agreeable leather fragrance |
| Grade 6 | Tolerable | Typical leather fragrance |
| Grade 5 | Borderline tolerable | Leather fragrance |
| Grade 4 | Objectionable | Strong leather fragrance |
| Grade 3 | Annoying | Annoying leather fragrance |
| Grade 2 | Severe | Very severe leather fragrance |
| Grade 1 | Intolerable | Intolerable |

### 3. Results and Discussion

Polyol and prepolymer components were premade before preparation of the polyurethane elastomers. Compositions were summarized and shown in Table 2.

When comparing E-01 or E-02 that utilized thiourea with E-05 or E-06 that used equivalent amounts of urea, tensile strength, elongation and adhesion performances are similar. However, the samples contained thiourea are strongly smelling (objectionable) and thus the odor performance were scored at 4 according to GMW3205-2016. Besides, these samples contained thiourea turned heavily yellow (yellow index of 31-46 after 72-h irradiation) after the UV irradiation, whereas those made from urea showed much better odor performances (scored at 7 according to GMW3205-2016) and more UV-resistant (yellow index<1 after 72-h UV-irradiation).

When comparing comparative example E-03 containing aromatic amine (DETDA) and inventive example E-07 containing equivalent molar amount of urea, E-07 is lower in cost due to the much lower price of urea compared to the aromatic amine, more UV-resistant (yellow index<1 after 72-h UV irradiation), and better in the performance of odor (scored at 7, compared to 6 of E-03 that showed slightly bitter smelling).

When comparing comparative example E-04 containing only ethylene glycol (MEG) and inventive examples E-05 to E-08 containing different amounts of urea or urea derivative bis(hydroxymethyl)urea, the inventive examples showed much higher tensile strengths, elongation at break, peel strengths and UV-stability, whereas cost and odor performances are similar.

TABLE 2
Formulations for polyurethane systems

| | Examples | | Com. 1 | Com. 2 | Com. 3 | Com. 4 | Inv. 1 | Inv. 2 | Inv. 3 | Inv. 4 |
|---|---|---|---|---|---|---|---|---|---|---|
| | Entries ^{a} | | E-01* | E-02* | E-03* | E-04* | E-05 | E-06 | E-07 | E-08 |
| Polyol | CP 6001 | | 60.81 | 60.81 | 60.81 | 60.81 | 60.81 | 60.81 | 60.81 | 60.81 |
| | EP 1900 | | 27.04 | 27.04 | 23.97 | 27.04 | 27.04 | 27.04 | 27.04 | 25.48 |
| | MEG | | 8.50 | 7.91 | 7.33 | 8.90 | 8.50 | 7.91 | 7.33 | 7.33 |
| | Urea | | | | | | 0.39 | 0.98 | 1.56 | |
| | Thiourea | | 0.39 | 0.98 | | | | | | |
| | 1,3- | | | | | | | | | |
| | bis(hydroxymethyl)urea | | | | | | | | | 3.12 |
| | DETDA | | | | 4.63 | | | | | |
| | BYK-A535 | | 0.10 | 0.10 | 0.10 | 0.10 | 0.10 | 0.10 | 0.10 | 0.10 |
| | Coscat 83 | | 0.16 | 0.16 | 0.16 | 0.16 | 0.16 | 0.16 | 0.16 | 0.16 |
| | Irganox 1135 | | 0.60 | 0.60 | 0.60 | 0.60 | 0.60 | 0.60 | 0.60 | 0.60 |
| | Tinuvin 571 | | 1.20 | 1.20 | 1.20 | 1.20 | 1.20 | 1.20 | 1.20 | 1.20 |
| | Tinuvin 765 | | 1.20 | 1.20 | 1.20 | 1.20 | 1.20 | 1.20 | 1.20 | 1.20 |
| Prepolymer | Hyperlast LE 5021 | | 57.45 | 56.82 | 57.89 | 57.91 | 57.93 | 58.01 | 58.15 | 58.02 |
| Condition | Mol_{NCO}/Mol_{OH} | | 1.04 | 1.04 | 1.04 | 1.04 | 1.04 | 1.04 | 1.04 | 1.04 |
| | Temperature (° C.) | | 23.00 | 23.00 | 23.00 | 23.00 | 23.00 | 23.00 | 23.00 | 23.00 |
| | | Target | | | | | | | | |
| Property | Hardness (Shore A) | 85-95 | 93 | 93 | 95 | 93 | 93 | 93 | 93 | 94 |
| | Tensile Strength | ≥10 | 12.02 ± | 11.31 ± | 16.56 ± | 9.01 ± | 13.02 ± | 11.85 ± | 11.43 ± | 11.65 ± |
| | (MPa) | | 1.12 | 0.72 | 0.64 | 0.64 | 1.54 | 0.96 | 0.66 | 0.58 |
| | Elongation (%) | ≥200 | 245 | 233 | 255 | 210 | 224 | 232 | 262 | 246 |
| | Adhesion - Peel | ≥55 | 55.18 | 55.46 | 70.33 | 48.03 | 56.71 | 62.45 | 75.18 | 69.80 |
| | Strength (N/cm)^{b} | | | | | | | | | |
| | Odor (ppm)^{c} | >=6 | 4 (Smelling) | 4 (Smelling) | 6 (Tracy | 7 | 7 | 7 | 7 | 7 |
| | | | | | bitter) | | | | | |
| | Yellow Index (72 h)^{d} | The | 31.34 | 46.29 | 10.57 | 6.37 | <1 | <1 | <1 | <1 |
| | | lower, | | | | | | | | |
| | | the | | | | | | | | |
| | | better | | | | | | | | |

Notes:
^{a} Stars (*) indicate comparative examples.
^{b}Peel strength determined at 90° using Instron apparatus.
^{c}Odor was determined according to GMW3205-2016.
^{d}Yellow index obtained after 72-h irradiance.

### 4. Conclusions

This disclosure discloses two-component polyurethane compositions comprising an isocyanate component containing at least one aromatic isocyanate, and a polyol component containing at least one polyether polyol, one sulfide-free urea or its derivatives, at least one alcohol chain extender.

The two-component polyurethane compositions provided by the present disclosure are useful for applications (for example, RIM process) to pursue advanced performances including excellent cost-efficiency, adhesion performance to in-mold child parts, light stability, low odor and outstanding mechanical strengths of products or parts manufactured thereby.

What is claimed is:

1. A two-component polyurethane composition, comprising,
(a) an isocyanate component that comprises:
at least one aromatic isocyanate compound, and
(b) a polyol component that comprises:
at least one polyether polyol compound,
a sulfide-free urea or a derivative thereof,
an organometallic catalyst, and
an alcohol chain extender,
wherein the isocyanate component and polyol component have an NCO/OH ratio of from 0.9:1 to 1.2:1

2. The two-component polyurethane composition according to claim 1, wherein the sulfide-free urea or a derivative thereof comprises the structure of the following formula: 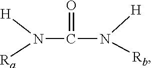
wherein Rₐ and R_{b} are independently H or C₁-C₁₀ aliphatic chain with OH or NH₂ as a terminal group.

3. The two-component polyurethane composition according to claim 1, wherein the sulfide-free urea or a derivative thereof is from 0.1% to 20% by weight of the polyol component.

4. The two-component polyurethane composition according to claim 1, wherein the at least one aromatic isocyanate compound is selected from the group consisting of modified or unmodified monomeric isocyanates, polymeric isocyanates, isocyanate-terminated prepolymers, and any combination thereof.

5. The two-component polyurethane composition according to claim 1, wherein the isocyanate component comprises a mixture of at least one monomeric aromatic isocyanate, at least one carbodiimide modified monomeric isocyanate and at least one prepolymer of monomeric aromatic isocyanates and C2 to C12 diols.

6. The two-component polyurethane composition according to claim 1, wherein the at least one aromatic isocyanate compound has an NCO content of between 12% and 32% by weight of the aromatic isocyanate compound.

7. The two-component polyurethane composition according to claim 1, wherein the at least one polyether polyol has an average hydroxyl group functionality of from 2 to 5.

8. The two-component polyurethane composition according to claim 1, wherein the at least one polyether polyol has an average molecular weight of from 800 to 12000 g/mol.

9. The two-component polyurethane composition according to claim 1, wherein the alcohol chain extender comprises a C2 to C12 polyol.

10. A polyurethane-based article made by using the two-component polyurethane composition according to claim 1.

11. A method of preparing a polyurethane-based article, comprising,
(i) providing an isocyanate component that comprises:
at least one aromatic isocyanate compound,
(ii) providing a polyol component that comprises:
at least one polyether polyol compound,
a sulfide-free urea or a derivative thereof, and
an alcohol chain extender,
(iii) combining the isocyanate component with the polyol component at an NCO/OH ratio of from 0.9:1 to 1.2:1 to form a reactive mixture, and
(iv) curing the reactive mixture to form a polyurethane-based article.

12. The composition of claim 1, wherein the organometallic catalyst is an organobismuth.
